(19) United States
(12) Patent Application Publication
(10) Pub. No.: US 2011/0126020 A1
(43) Pub. Date: May 26, 2011

(54) CONTENT DISCLOSURE SYSTEM AND METHOD FOR GUARANTEEING DISCLOSED CONTENTS IN THE SYSTEM

(76) Inventor: Toshiyuki Isshiki, Tokyo (JP)

(21) Appl. No.: 12/674,465

(22) PCT Filed: Aug. 26, 2008
(86) PCT No.: PCT/JP2008/065216

§ 371 Date: Feb. 22, 2010

(30) Foreign Application Priority Data
Aug. 29, 2007 (JP) 2007-222093

(51) Int. Cl. H04L 9/32

(52) U.S. Cl. 713/176

(57) ABSTRACT

Means for confirming the validity of the contents of a change made to a disclosed content is provided for use in a content disclosure system in which a signed content may be modified and the validity of the modified signed content may be verified using a verification key corresponding to a signature on the content before the modification. When a signed changed-content is created based on a request to change a signed content, a signed content change device connected to the content disclosure system generates restoration validity proving data for restoring the signed changed-content to a state before the change and proving the validity of the restored Contents. A verification key of the signed content, the signed changed-content, and the restoration validity proving data are provided to allow a third party to confirm the validity of the content.

### REFERENCE TO RELATED APPLICATION

This application is the National Phase of PCT/JP2008/065216, filed Aug. 26, 2008, which is based upon and claims the benefit of the priority of Japanese patent application No. 2007-222093 filed on Aug. 29, 2007, the disclosure of which is incorporated herein in its entirety by reference thereto.

### TECHNICAL FIELD

The present invention relates to a content disclosure system and a disclosed content guaranteeing method used in the system, and more particularly to a method for guaranteeing the validity of the contents of a modification to a disclosed content in a content disclosure system that guarantees the validity of a signed content and allows for a modification to the content for protecting privacy information and to a content disclosure system having the function to implement the method.

### BACKGROUND

The electronic signature (digital signature) technology has been used as a technology for confirming who is the data creator (signer) of, and ensuring that data is not altered in, electronic content such as an electronic document. An electronic signature, a technology provided for detecting a transformation in the content, is characterized in that, once signed, the document can neither be changed nor processed (for example, deletion (invisualization) of a particular description, replacement of words, etc. are not allowed).

Recently, as the information disclosure law requires the administrative organs to disclose more and more information in the form of electronic documents, there is a need for protecting information such as personal information and national security information. To meet this need, a technology is required that allows a predetermined modification to be added for protecting privacy information and secret information while ensuring the validity (originality) of signed electronic documents.

For example, Patent Document 1 proposes a document management method for adding an updater's electronic signature and update history information each time an update is made and for performing the reverse operation to restore the document to the original form and verify the restored document. However, the method described in that publication requires that an update made by an updater be restored and its contents be verified to verify the validity of an electronic document in a particular generation, meaning that the above-described security requirements for information disclosure by means of electronic documents, that is, “protection of privacy information and secret information”, cannot be satisfied (see 0049-0050 in the publication).

In view of the foregoing, Patent Documents 2-4 and Non-Patent Documents 2 and 3 propose technologies for verifying the validity (originality) of a signed electronic document without leaking the contents deleted by the updater described above. Those technologies are called an “electronic document sanitizing technology” because they are an electronic document equivalence of paper document sanitization.

The electronic document sanitizing technology described above updates signature data, added to a signed document, according to the contents of a change in order to allow the description, which is included in the changed signed document but should not be disclosed, to be deleted (invisualized) or to be replaced by meaningless words while still allowing the document to be verified using the verification key used when the signature was added to the original signed document.

Non-Patent Documents 4 and 5 are documents on the Chameleon hash function related to the present invention.

### Patent Document 1:

JP Patent Kokai Publication No. JP-P2003-216601A

### Patent Document 2:

JP Patent Kokai Publication No. JP-P2006-60722A

### Patent Document 3:

JP Patent Kokai Publication No. JP-P2005-51734A

### Patent Document 4:

JP Patent Kokai Publication No. JP-P2007-27920A

### Non-Patent Document 1:

“Sanitizable Signatures”, G. Ateniese, D. H. Chou, B. de Medeiros, G. Tsudik. ESORICS 2005. LNCS 3679, pp. 159-177, Springer, 2005.

### Non-Patent Document 2:

“Content Extraction Signatures”, R. Steinfeld, L. Bull, Y. Zheng. ICISC 2001. LNCS 2288, pp. 285-304, Springer, 2001.

### Non-Patent Document 3:

“Sanitizable Signature with Secret Information”, M. Suzuki, T. Isshiki, K. Tanaka. Information and Security Symposium (SCIS2006), 4A1-2, 2006.

### Non-Patent Document 4:

“On the key-exposure problem in chameleon hashes”, G. Ateniese and B. deMedeiros. SCN'04, LNCS 3352. Springer, 2005.

### Non-Patent Document 5:

“Chameleon hashing without key exposure”, X. Chen, F. Mang, and K. Kim. ISC'04, LNCS 3225, pp. 87-98. Springer, 2004.

### SUMMARY

The entire disclosures of the above-mentioned Patent Documents 1-4 and Non-Patent Documents 1-5 are incorporated herein by reference thereto. An analysis on the related technologies by the present inventor will be given below.

However, when the electronic document sanitizing technology described above is used, there is a need to consider the possibility that a person, who adds a change to a signed document, intentionally manipulates the information and adds a change to a portion of the document that should be disclosed without change.

Especially, when a replacement was made using the technology disclosed in Non-Patent Document 1, it is not easy to identify what portion of a disclosed document was replaced. In this case, if the signer who added the signature to the original document (called an “original signer”) is found, the signed document may be generated again and the validity of the change contents added to the original signed document (hereinafter called a “signed original document”) may be confirmed.

However, the document to be verified is sometimes too old to find the original signer, in which case the validity of the change contents may not be confirmed. And, in some other case, though there is no problem if the signed original document before being changed is saved, there is a possibility that the original document is sometimes discarded (deleted) to avoid the risk of the leakage of the original document or that the signature on the original document is invalid because the signature or verification key is invalidated.

As described above, the problem with the conventional electronic document sanitizing technology is that, if there is neither the original signer nor the signed original document, it is impossible to confirm whether or not the changes added to a disclosed signed document are valid.

In view of the foregoing, it is an object of the present invention to provide a content disclosure system and a disclosed content guaranteeing method in the system that guarantee the validity of a signed content, allow for a change/modification to the content to protect privacy information, and verify the validity of modification/change contents to the signed content.

According to a first aspect of the present invention, there is provided a disclosed content validity guaranteeing method in which, when a changer changes a part of contents of a signed content using a verification key, corresponding to a signature key of an original signer, based on the signed content to which an electronic signature is added using the signature key of the original signer, a signed changed-content having the signature of the original signer is created for the changed-content and, when a verifier verifies that the content before the change is signed using the signature key of the original signer with information on the changed part before the change concealed, the verification key of the original singer is used, wherein when the signed changed content is created, the signature of the original signer and contents of the content before the change for a change position are made to correspond to a part or a whole of the change position and the correspondence is saved in a restoration validity proving data storage device.

According to a second aspect of the present invention, there is provided a content disclosure system that includes a change device comprising: a change processing unit that accepts a signed content having a signature of an original signer, a verification key of the original signer, and a request to change the signed content and creates a signed changed-content; and a signature verification unit that generates restoration validity proving data for restoring the signed changed-content to a state before the change and proving validity of the restored contents, based on the request to change the signed content when the signed changed-content having the signature of the original signer is created, and provides the generated restoration validity proving data to a restoration device wherein said restoration device restores the signed changed-content having the signature of the original signer to a state before the change using the verification key of the original signer, the signed changed content, and the restoration validity proving data and verifies that the signed changed-content is restored correctly using the verification key of the original signer.

According to a third aspect of the present invention, there is provided a computer program that causes a computer to function as the devices of the content disclosure system described above and the devices.

The meritorious effects of the present invention are summarized as follows.

According to the present invention, content before a modification may be restored from the modified signed content while ensuring its validity. In addition, the validity of the contents of a change made while content is disclosed may be confirmed using the restored content. Therefore, the present invention inhibits a malicious change action against disclosed signed content.

### BRIEF DESCRIPTION OF THE DRAWINGS

FIG. 1 is a diagram showing the configuration of a document disclosure system in one exemplary embodiment of the present invention.

FIG. 2 is a block diagram showing the detailed configuration of a signature device in FIG. 1.

FIG. 3 is a block diagram showing the detailed configuration of a change position specification device shown in FIG. 1.

FIG. 4 is a block diagram showing the detailed configuration of a change device shown in FIG. 1.

FIG. 5 is a block diagram showing the detailed configuration of a verification device shown in FIG. 1.

FIG. 6 is a block diagram showing the detailed configuration of a restoration device shown in FIG. 1.

FIG. 7 is a reference diagram showing the devices included in the configuration shown in FIG. 1 and involved in the original signature generation processing.

FIG. 8 is a flowchart showing the flow of the original signature generation processing.

FIG. 9 is a reference diagram showing the devices included in the configuration shown in FIG. 1 and involved in the signed original document change processing.

FIG. 10 is a flowchart showing the flow of the signed original document change processing.

FIG. 11 is a reference diagram showing the devices included in the configuration shown in FIG. 1 and involved in the signed changed-document verification processing.

FIG. 12 is a flowchart showing the flow of the signed changed-document verification processing.

FIG. 13 is a flowchart showing the flow of the original signature generation processing using the Chameleon hash function.

### PREFERRED MODES

Next, preferred exemplary embodiments of the present invention will be described more in detail below with reference to the drawings. In the description below, â{b} means “a to the b-th power”, and a_{b} indicates the state in which “a is followed immediately by the subscript b”. Bit concatenation is denoted as “∥”. For example, when a=10 (in binary) and b=01, the concatenation is represented as a∥b=1001.

In addition, an original document that is the source of a disclosed content is divided into components (hereinafter called blocks). Blocks may be blocks each of which is a one-byte block and the first of which begins at the start of an original document or, when a document is a structured document, may be components of the document. In the description below, suppose that an original document is composed of n blocks to each of which an index is allocated. That is, an original document M is represented as M_1, . . . , M_n.

### First Exemplary Embodiment

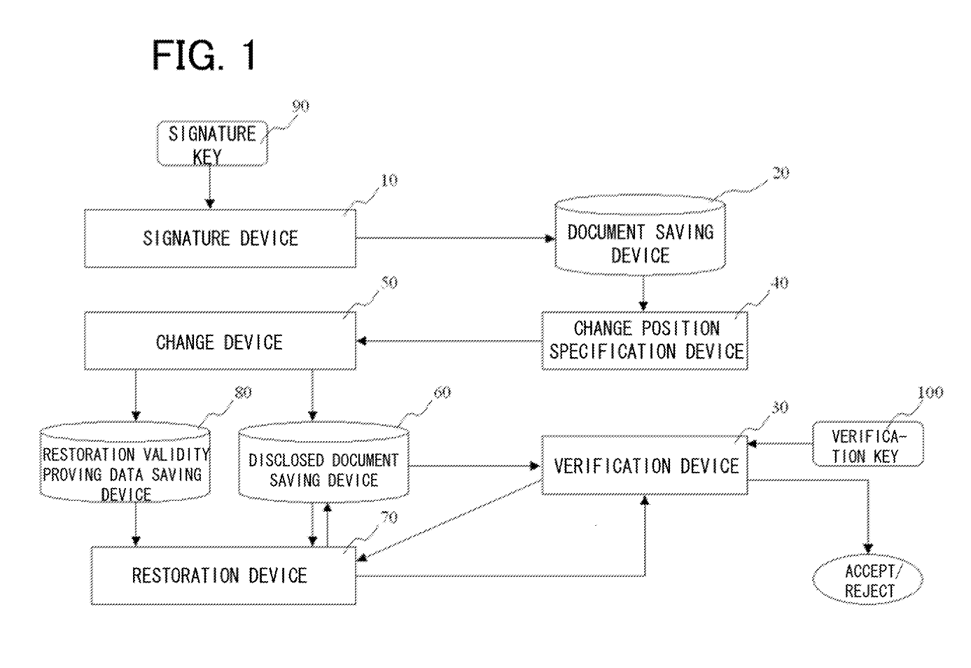

FIG. 1 is a diagram showing the configuration of a document disclosure system in one exemplary embodiment of the present invention. FIG. 1 shows a document disclosure system comprising a signature device 10, a document saving device 20, a verification device 30, a change position specification device 40, a change device 50, a disclosed document saving device 60, a restoration device 70, and a restoration validity proving data saving device 80.

The signature device 10 is an information processing device that determines an original document and adds a signature to the original document using a signature key 90. For example, the signature device 10 is operated by a document issuing operator (signer) that issues formal documents. For example, when the signature device 10 is used for adding a signature to a formal document, the signer is the ministry or administrator of a government agency.

The document saving device 20 is a device in which signed original documents are saved, and the change position specification device 40 is an information processing device that selects a document, which will be disclosed, from the signed original documents saved in the document saving device 20, searches the selected document for non-disclosure information, and specifies the index of a block including the non-disclosure information. For example, the change position specification device 40 is operated by a censor operator who censors the contents of a document created by a document issuer and decides whether to disclose the created document. When the change position specification device 40 is used for censoring formal documents, the censor is a staff member of the censor department in charge of censoring documents when those documents are disclosed.

The verification device 30 is an information processing device that selects a document, which will be verified, from the signed changed-documents saved in the disclosed document saving device 60 and verifies the signature of the selected signed changed-document. In addition, if an original word in a block in the signed changed-document is necessary, the verification device 30 specifies the index of the block and requests the restoration device 70 to perform restoration. The verification device 30 is operated, for example, by a person in charge of confirming a disclosed formal document. When the verification device 30 is used for verifying formal documents, the verifier is citizens, other formal verification organizations, or judges.

The change device 50 is an information processing device used to change the contents of a block specified by the change position specification device 40. For example, the change device 50 is operated by a sanitization operator (changer) who adds an appropriate change (for example, sanitization processing) to a document according to censor results. When the change device 50 is used to change a formal document, the sanitization operator is a staff member of the department in charge of clerical work on information disclosure.

The disclosed document saving device 60 is a device in which signed changed-documents whose non-disclosure information has been changed are saved, and the restoration validity proving data saving device 80 is a device in which data used for restoration is saved.

The restoration device 70 is an information processing device that judges if a block, which is specified by the verification device 30 as a block to be restored, may be restored, restores the block if it may be restored, and generates a signed restored-document. The restoration device 70 is operated, for example, by a restoration operator who accepts a restoration request from the verifier and judges if the restoration is necessary. When the change device 50 is used for restoring a formal document, the restoration operator is a staff member of the department in charge of the clerical work on information disclosure or a staff member of the information office.

The devices described above, from the signature device 10 to the restoration validity proving data saving device 80, are interconnected via a network such as the Internet. However, to prevent the saved documents from being leaked, it is preferable to limit access to the document saving device 20 in such a way that only the signature device 10 can write thereto and only the change position specification device 40 can read therefrom or to place the document saving device 20 on a network on which only the signature device 10 and the change position specification device 40 have access thereto.

The signature device 10 receives the signature key sk_s of an original signer S as the signature key 90. In addition, the verification device 30, change position specification device 40, change device 50, and restoration device 70 receive a verification key vk_s (indicated as verification key 100 in FIG. 1) that corresponds to the signature key sk_s. The verification key vk_s may be input to those devices in conjunction with a document to which the signature is added or may be obtained from a home page disclosed on the network. It is desirable that this verification key be a key with a public key certificate issued using the PKI (Public Key Infrastructure) technology that is known.

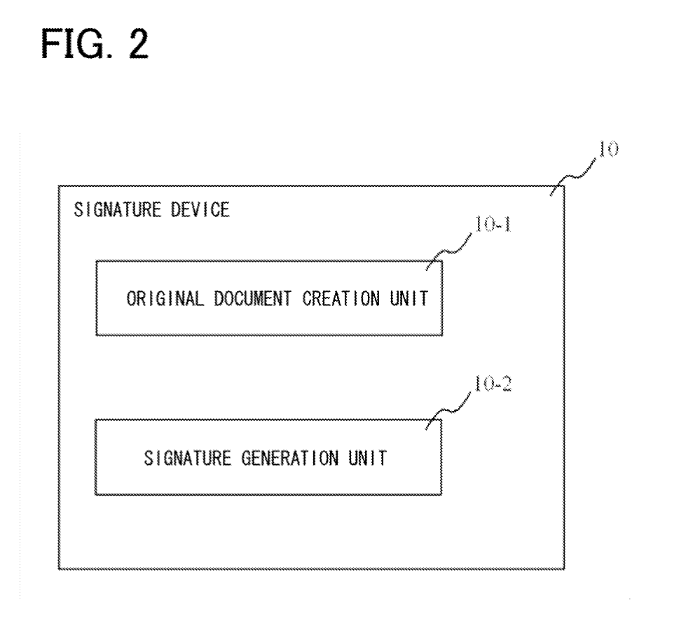

Next, the following describes the detailed configuration of the devices described above with reference to FIG. 2 to FIG. 6. FIG. 2 is a block diagram showing the detailed configuration of the signature device 10 in FIG. 1. As shown in FIG. 2, the signature device 10 comprises an original document creation unit 10-1 that creates an original document and a signature generation unit 10-2 that receives the signature key of a signer and an original document created by the original document creation unit 10-1 and generates a signed original document.

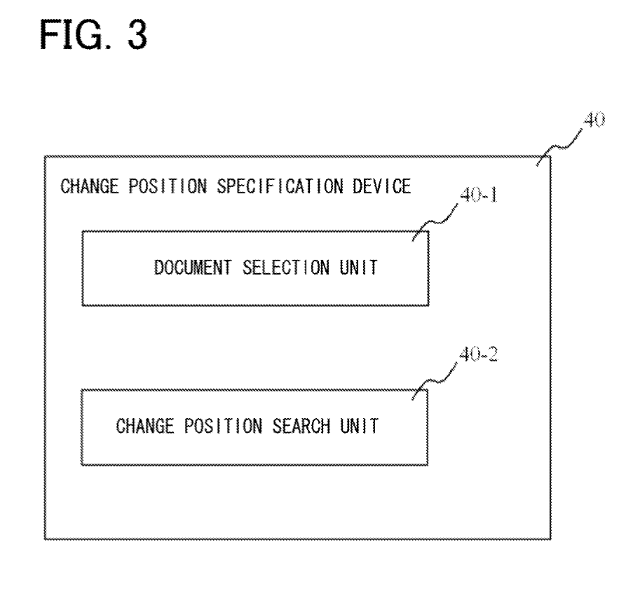

FIG. 3 is a block diagram showing the detailed configuration of the change position specification device 40 shown in FIG. 1. As shown in FIG. 3, the change position specification device 40 comprises a document selection unit 40-1 that selects a document, which will be disclosed, from the signed original documents saved in the document saving device 20 and a change position search unit 40-2 that receives the signed original document selected by the document selection unit 40-1, searches the received signed original document for information that should not be disclosed (non-disclosure information), and outputs a set SIND composed of the indexes of the blocks including non-disclosure information.

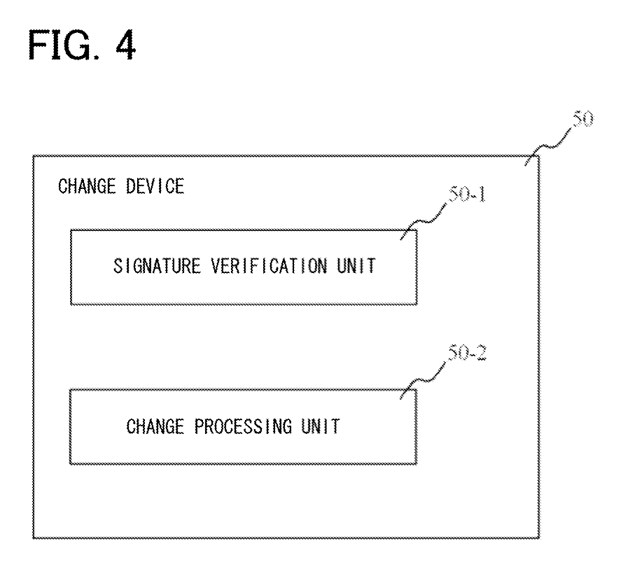

FIG. 4 is a block diagram showing the detailed configuration of the change device 50 shown in FIG. 1. As shown in FIG. 4, the change device 50 comprises a signature verification unit 50-1 that receives a specified signed original document from the change position specification device 40, verifies the signature, and outputs the verification result (accept or reject) and a change processing unit 50-2 that receives a signed original document for which “accept” is output by the signature verification unit 50-1 and the set SIND composed of the indexes of the blocks including non-disclosure information, changes the contents of the blocks specified by SIND, and outputs the signed changed-document, restoration data, and its proving data.

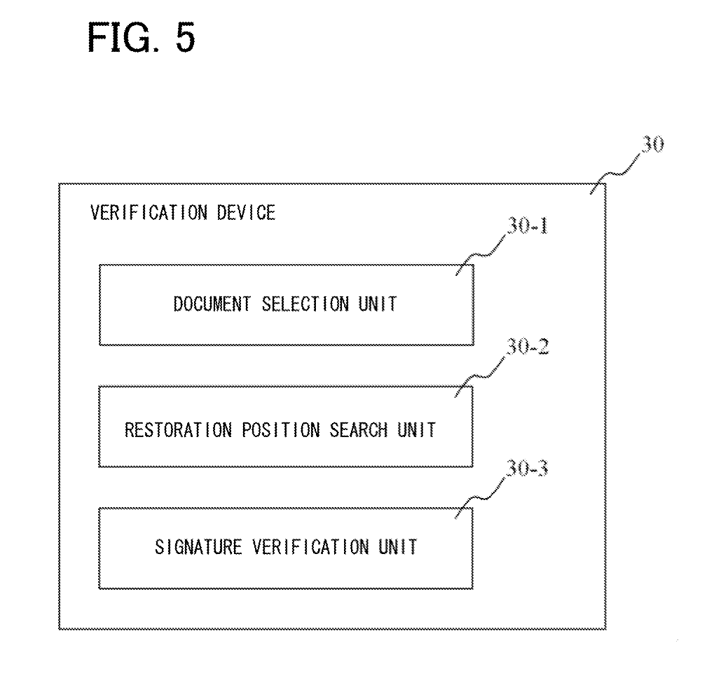

FIG. 5 is a block diagram showing the detailed configuration of the verification device 30 shown in FIG. 1. As shown in FIG. 5, the verification device 30 comprises a document selection unit 30-1 that receives a verification key and selects a document, which will be verified, from the signed changed-documents saved in the disclosed document saving device 60, a restoration position search unit 30-2 that receives a signed changed-document selected by the document selection unit 30-1, searches the blocks of the original document for the blocks that must be restored because the blocks are to be disclosed but have been changed, and outputs the a set RIND composed of the indexes of the restoration-required blocks, and a signature verification unit 30-3 that receives the signed restored-document, verifies the signature, and outputs the verification result (accept or reject).

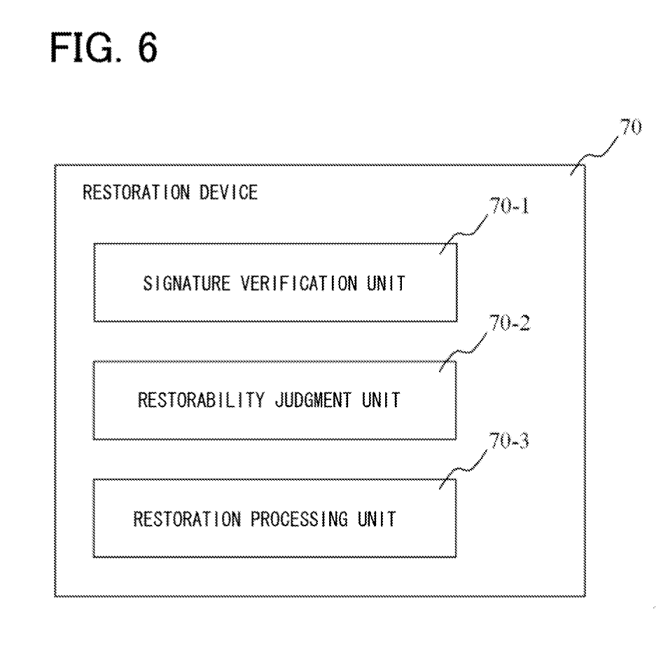

FIG. 6 is a block diagram showing the detailed configuration of the restoration device 70 shown in FIG. 1. As shown in FIG. 6, the restoration device 70 comprises a signature verification unit 70-1 that receives a verification key vk_s, a signed changed-document, and the set RIND composed of the indexes of the restoration-required blocks, verifies the signed changed-document, and outputs the verification result (accept or reject), a restorability judgment unit 70-2 that receives a signed changed-document for which “accept” is output by the signature verification unit 70-1 and the set RIND composed of indexes, confirms if the blocks specified RIND may be restored, and outputs the confirmation result (OK or NG), and a restoration processing unit 70-3 that receives a signed changed-document for which OK is output by the restorability judgment unit 70-2, the set RIND composed of indexes, and the restoration validity proving data, restores the blocks, and output a signed restored-document.

Next, with reference to the drawings, the following describes in detail a sequence of operations of the document disclosure system described above in which a signed document is changed and disclosed and the changed contents are verified by the restoration processing introduced by the present invention.

### [Signed Original Document Creation Processing]

First, the following describes the processing in which the original signer S selects an original document and adds the signature of the original signer S to the original document.

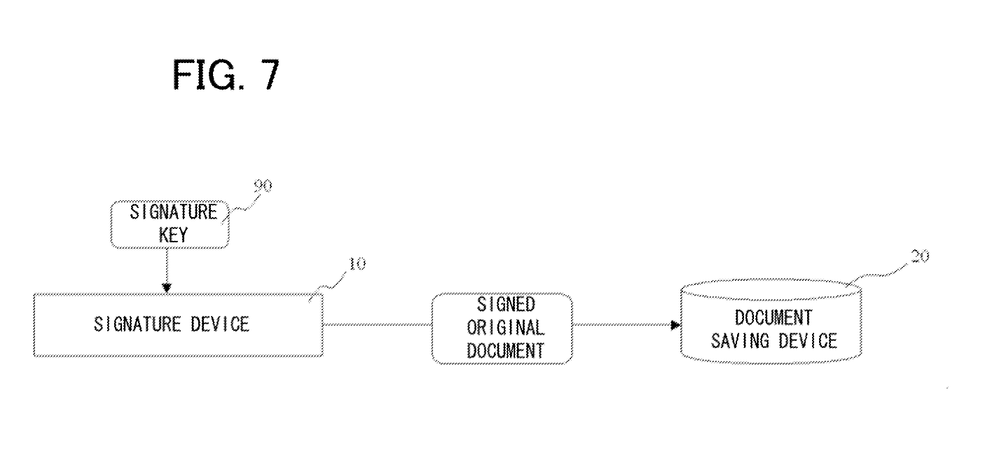

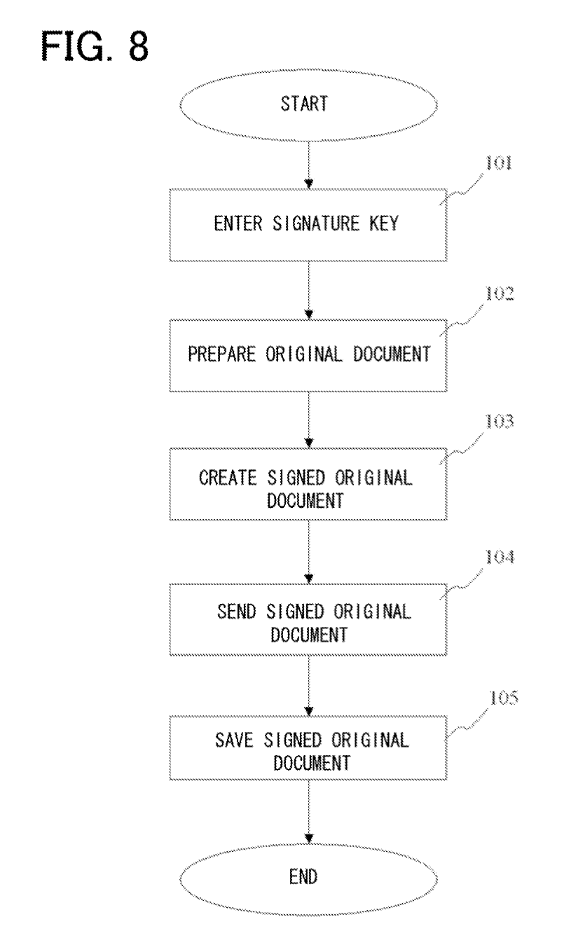

FIG. 7 is a reference diagram showing the devices included in the configuration shown in FIG. 1 and involved in the signed original document creation processing. FIG. 8 is a flowchart showing the flow of the signed original document creation processing. In the example below, the original signer S adds the signature to an original document using the signature key sk_s and the verification key vk_s stored in advance in an IC card or a flash memory.

The original signer S enters the signature key sk_s into the signature device 10 via the access interface of the IC card or the flash memory (step 101).

Next, the original document creation unit 10-1 prepares an original document M to which a signature is to be added (step 102). Although, like the signature key sk_s, the original document M may be entered via an IC card or a flash memory, the original document creation unit 10-1 may also create it through a dialog with the original signer S. For example, an original document may be created on the signature device 10 if it has an interface, such as a keyboard, and a word processor.

Next, the signature generation unit 10-2 adds an electronic signature to the original document M using the signature key sk_s to create a signed original document OSIG (step 103).

In addition, the signature generation unit 10-2 sends the created signed original document OSIG to the document saving device 20 (step 104). The document saving device 20 that receives the signed original document OSIG stores the received signed original document OSIG (step 105).

### [Signed Original Document Change Processing]

Next, the following describes the processing for changing the contents of the blocks that are included in the blocks of a signed original document to be disclosed and that include non-disclosure information such as personal information.

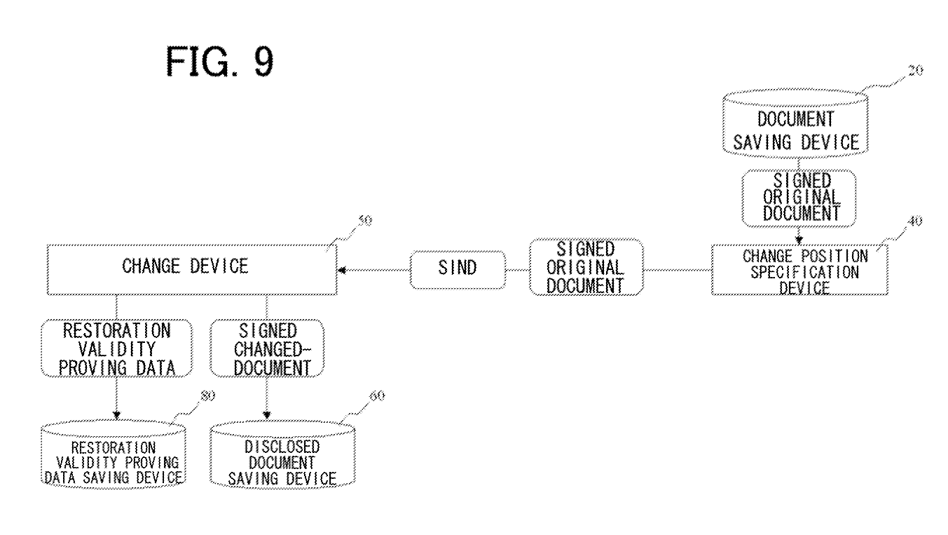

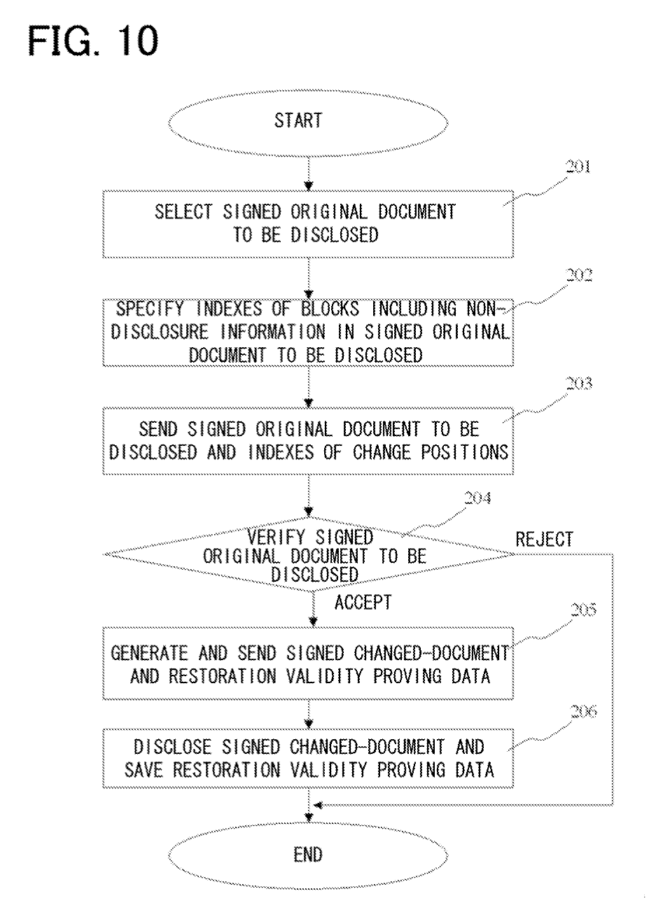

FIG. 9 is a reference diagram showing the devices included in the configuration shown in FIG. 1 and involved in the signed original document change processing. FIG. 10 is a flowchart showing the flow of the signed original document change processing. In the example below, assume that the signed original document creation processing described above has been performed and multiple signed original documents are already stored in the document saving device 20.

First, the document selection unit 40-1 selects a signed original document OSIG, which will be disclosed, from the signed original documents saved in the document saving device 20 according to a user instruction (step 201).

Next, the change position search unit 40-2 searches the blocks, included in the selected signed original document OSIG, for blocks including non-disclosure information, and generates a set SIND composed of the indexes of the blocks including non-disclosure information (step 202). The search for blocks including non-disclosure information may be made by a user who performs the change processing or the search may be made according to the specification (disclose/non-disclose) specified by the original signer S or based on the result of document analysis.

Let M_{i_1}, . . . , M_{i_k} be blocks included in the original document M=M_1, . . . , M_n and including non-disclosure information. Then, SIND={i_1, . . . , i_k} where i_1, . . . , i_k are integers from 1 to n and k is equal to or smaller than n.

Next, the change position search unit 40-2 sends a set (OSIG, SIND), composed of the signed original document and the change position indexes, to the change device 50 (step 203).

The change device 50, which has received the set (OSIG, SIND) of the signed original document OSIG and the indexes of blocks including non-disclosed information, causes the signature verification unit 50-1 to verify the signed original document OSIG using the verification key vk_s (step 204). If the signature on the signed original document OSIG is invalid, the signature verification unit 50-1 judges the signature as “reject” and stops the subsequent operations.

If the signature verification unit 50-1 confirms that the signature is valid, the change processing unit 50-2 changes the contents of the blocks, specified by the set SIND of the indexes of the blocks including non-disclosure information, to generate a signed changed-document SSIG (step 205).

In this case, it is only required that a changed block contains contents by which the contents before the change cannot be estimated. For example, the contents of the block may be a hashed value of a message or a random value or may be the contents entered by a user, who is operating the change device 50, via the keyboard. The changed contents may also be contents replaced by the contents stored in an IC card or a flash memory. After that, the change processing unit 50-2 sends the generated signed changed-document SSIG to the disclosed document saving device 60.

In addition, the change processing unit 50-2 sends data (hereinafter called restoration data and restoration validity proving data) RI, which is used to restore the blocks specified by the set SIND composed of the indexes of the blocks including non-disclosure information and to prove the validity of the restoration, to the restoration validity proving data saving device 80.

The disclosed document saving device 60 stores and discloses the received signed changed-document SSIG. The document is disclosed, for example, by uploading the document to the Internet. The restoration validity proving data saving device 80 stores the received restoration data and restoration validity proving data RI (step 206).

### [Signed Changed-Document Verification Processing]

Next, the following describes the processing for verifying a signed changed-document that is disclosed.

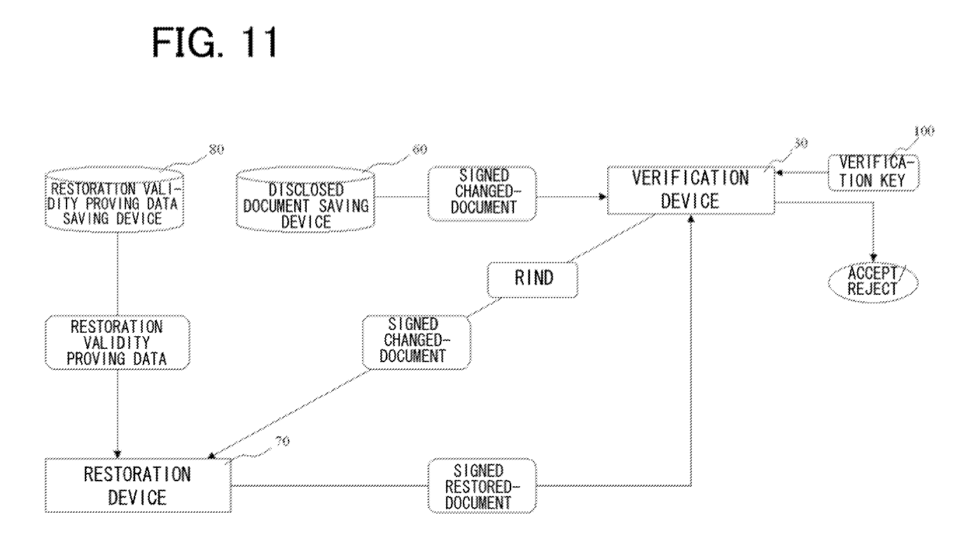

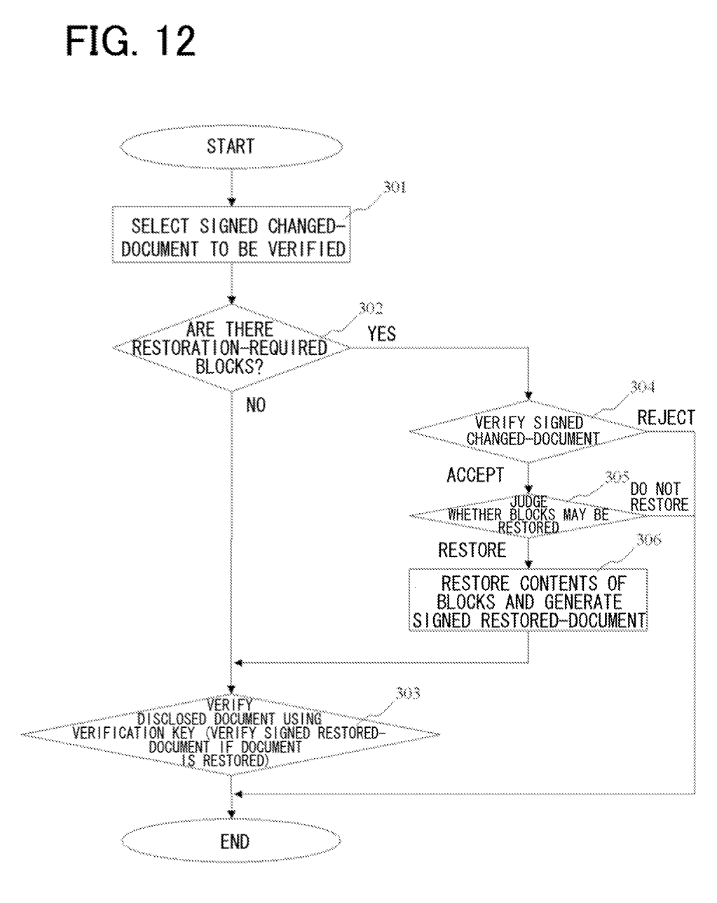

FIG. 11 is a reference diagram showing the devices included in the configuration shown in FIG. 1 and involved in the signed changed-document verification processing. FIG. 12 is a flowchart showing the flow of the signed changed-document verification processing. In the example below, assume that the signed original document change processing described above has been performed and multiple signed changed-documents are already stored in the disclosed document saving device 60.

First, the document selection unit 30-1 selects a signed changed-document SSIG, whose validity is to be verified, from the signed changed-documents, saved in the disclosed document saving device 60, according to a user instruction (step 301).

Next, the restoration position search unit 30-2 searches the changed blocks, included in the selected signed changed-document SSIG, for restoration-required blocks, and generates a set RIND composed of the indexes of those blocks. The search for restoration-required blocks may be made according to the specification (disclose/non-disclose) specified in advance by the original signer S or based on the result of document analysis.

If there are restoration-required blocks, the restoration position search unit 30-2 sends a set (SSIG, RIND), composed of the signed changed-document and the indexes of the restoration-required blocks, to the restoration device 70 (Yes in step 302).

The signature verification unit 70-1 of the restoration device 70, which has received the signed changed-document SSIG and the set RIND composed of the indexes of the restoration-required blocks, verifies the signed changed-document SSIG using the verification key vk_s (step 304). In this case, if it is found that the signature is invalid, the signature verification unit 70-1 outputs a message indicating that the signature is invalid and stops the processing.

On the other hand, if the signature on the signed changed-document SSIG is valid, the restorability judgment unit 70-2 judges whether or not the blocks, specified by the set RIND composed of the indexes of the restoration-required blocks, may be restored (step 305). Whether or not the blocks may be restored is decided according to the authority given to the user who is operating the restoration device 70 and the contents of the signed changed-document SSIG. If there is a block that must not be restored, the restorability judgment unit 70-2 outputs a message indicating that the block may not be restored and stops the subsequent processing.

Note that, if there is a block that must not be restored, only a portion that may be restored may be restored instead of immediately stopping the processing. For example, by replacing the initially-received set RIND composed of the indexes of the restoration-required blocks with a set composed of the indexes of the blocks that may be restored, the subsequent processing may be continued.

If it is judged that all blocks, specified by the set RIND composed of the indexes of the restoration-required blocks, may be restored, the restoration processing unit 70-3 restores the contents of the blocks, which have the indexes specified by the set RIND composed of the indexes of the restoration-required positions, using the signed changed-document SSIG, the set RIND composed of the indexes of the restoration-required positions, and restoration data and restoration validity proving data RI and, after that, generates a signed restored-document RSIG. In addition, the restoration processing unit 70-3 sends the generated signed restored-document RSIG to the verification device 30 (step 306).

The signature verification unit 30-3 of the verification device 30, which has received the signed restored-document RSIG, verifies the signed restored-document RSIG using the verification key vk_s. In addition, when it is determined in step 302 described above that there is no block to be restored, for example, when there is no changed block but the document is directly disclosed, the signature verification unit 30-3 verifies the signed changed-document SSIG using the verification key vk_s (step 303). If the signature on the signed restored-document RSIG or on the signed changed-document SSIG is valid, the signature verification unit 30-3 accepts the signature; if the signature is invalid, the signature verification unit 30-3 outputs a message indicating rejection.

In this exemplary embodiment, a signed changed-document may be restored as described above using the restoration data, used to restore the state to the state before the change, and the restoration validity proving data used to prove the validity of the restored contents.

The document disclosure system in the First exemplary embodiment of the present invention described above may be applied to an actual business (document disclosure business) as described below. For example, a document issuer (a user on the signature device 10), who has created a document to be disclosed which includes personal information, determines the signature key sk_s and the corresponding verification key vk_s, and makes the verification key publicly known by means of newspapers or the home page. In addition, the document issuer sends the verification key to a censor operator (a user on the change position specification device 40), a sanitization operator (a user on the change device 50), a general user (a user on the verification device 30) who receives the disclosed document, and a restoration operator (a user on the restoration device 70).

Next, the document issuer enters the signature key sk_s into the signature device 10 to issue the document which will be disclosed and to which the issuer's signature is added, and saves the document in the document saving device 20.

Next, the censor operator uses the change position specification device 40 to censor the contents of the singed original document saved in the document saving device 20, specifies changes (for example, sanitization) to be added when the document is disclosed, and sends the document to the sanitization operator.

The sanitization operator uses the change device 50 to add changes to the specified positions and, at the same time, generates restoration validity proving data, and saves the changed document and the restoration validity proving data respectively in the disclosed document saving device 60 and the restoration validity proving data saving device 80.

A general user uses the verification device 30, such as his or her own personal computer, to confirm the contents of a signed changed-document saved in the disclosed document saving device 60, specifies a position to be restored, and sends the specification to the restoration operator.

The restoration operator receives the restoration validity proving data from the restoration validity proving data saving device 80 and uses the restoration device 70 to judge if the position required by the general user may be restored. If it is judged that the contents of the required position may be restored, the restoration operator restores the contents and sends the signed restored-document to the user. If it is determined that the contents of the required position may not be restored, the restoration operator sends a message indicating the fact to a general user.

In judging if the contents of a position may be restored, a rule (disclosure rule) may be established stating that the contents may be restored only when the restoration requesting user is a person or a family member of the person whose personal information is described in the changed position but not when the restoration requesting user is not anyone of them. It is also possible to give special authority to an auditor who inspects whether the operation is performed properly.

The sanitization operator may accept the sanitization job from the document issuer or the censor operator as an outsourced job and charge a commission on the sanitization. In addition, the sanitization operator may receive a restoration request from the user and charge a commission on the sanitization.

The censor operator and the sanitization operator may be different operators or the same operator. In addition, the sanitization operator and the restoration operator may be different operators or the same operator.

### Second Exemplary Embodiment

Next, a Second exemplary embodiment of the present invention will be described in which the configuration is the same as that of the First exemplary embodiment described above and the electronic document sanitization technology described in Patent Documents 2-4 is used. Although any of the electronic document sanitization technologies described in Patent Documents 1, 2, and 3 and Non-Patent Document 3 may be used in the present invention, the electronic document sanitization technology described in Non-Patent Document 3 is used in the description below.

The description of Patent Documents 1-3 is incorporated by reference into this specification.

Before describing this exemplary embodiment, the following describes the signature scheme introduced in Non-Patent Document 3. The signature scheme described in Non-Patent Document 3 is a scheme in which a change to a signed document is made only by removing the contents or replacing the contents by meaningless words. The signature scheme described in Non-Patent Document 3 is a technology for proving safety by using pairing, assuming the presence of an ideal hash function called a random oracle, and making a mathematical assumption.

The signature scheme described in Non-Patent Document 3 comprises four steps: key setup, signature generation, sanitization, and signature verification. Now, assume that the signer A adds a signature to an electronic document, the sanitizer S sanitizes non-disclosure information included in the electronic document to which A has added the signature and discloses the sanitized document, and the verifier V verifies the disclosed sanitized electronic document. The following sequentially describes the steps described above.

### [Key Setup]

First, the following describes key setup. The signer A determines the security parameter k. Next, the signer A selects a k-bit prime number q and generates a pairing set (G_1,G_2,G_T,e(·, ·)) of order q. That is, the number of elements of G_1,G_2, and G_T is q. G_1,G_2, and G_T of the pairing set (G_1,G_2,G_T,e(·, ·)) are finite groups having the same order q, and e(·, ·) is a map from G_1×G_2 to G_T. e(ĝx,ĥy)=e(g,h)̂{xy} is satisfied for the element g of any G_1, element h of G_2, and the elements x and y of a set of integers from 1 to q-1 (hereinafter called Z*_q), and e(g,h)≠1 is satisfied where g is a generator of G_1 and h is a generator of G_2.

Next, the signer A randomly selects x from the generator g_2 of G_2 and Z*_q and calculates Y=g_2̂{x}.

In addition, the hash function H which returns G_{1} is generated from a set of binary series of an arbitrary length.

In this case, the verification key vk of the signer A is generated as (k,q,(G_1,G_2,G_T,e),g_2,Y,H) and is disclosed. The signature key sk corresponding to the verification key vk is (x,vk).

### [Signature Generation]

The following describes signature generation. In the description below, it is assumed that the signer A having the signature key sk=(x,vk) adds the signature to the original document M=(M_1,M_2, . . . , M_n) composed of n blocks.

First, the signer A randomly selects k-bit r_1, . . . , r_{n+1} and sets R=(r_1, . . . , r_{n+1}).

Next, the signer A calculates w_i=H(M_i∥r_i) and then calculates w_{n+1}=H(w_1∥w_2∥ . . . ∥w_n,r_{n+1}) (where i is 1,2, . . . , n).

In addition, the signer A calculates A_i=(w_i)̂x for i=1,2, . . . , n+1 and calculates D=A_1×A_2× . . . ×A_{n+1}. In this case, the original signature data is σ=(M,D,R) and the sanitization data is SI={A_1, . . . , A_n}. If there is a block i that the signer A does not desire to sanitize, it is possible not to include Ai in the sanitization data.

### [Sanitization]

Next, the following describes sanitization. The sanitizer S receives as the input the verification key vk, the signature data σ=(M,D,R) and the sanitization data SI={A_1, . . . , A_n} for the original document M, and the set SIND={j_1, . . . , j_k} composed the indexes of the blocks to be sanitized. Note that j_1, . . . , j_k, which indicate the indexes of the blocks to be sanitized, are integers that satisfy 1≦j_1<j_2< . . . <j_k≦n.

The sanitizer S first calculates w_i=H(M_i∥r_i) for i=1,2, . . . , n. Next, a check is made if e(w_i,Y)=e(A_i,g_2) is satisfied. If there is i that does not satisfy the equation, the message is output to indicate that the original signature data a is an invalid signature and the processing is stopped.

If the equation is satisfied for all i and the validity of the original signature data σ is confirmed, the sanitizer S calculates D′=D/(A_{j_1}× . . . ×A_{j_k}) for the indexes j_1, . . . , j_k included in SIND. The sanitizer S determines the document, generated by removing M_{j_1}, . . . , M_{j_k} from M, as the document M′. In addition, the sanitizer S generates the set R′ by removing r_{j_1}, . . . , r_{j_k} from R and calculates IND={1,2, . . . , n}/SIND. That is, IND is composed of the indexes of the blocks which will be disclosed, where j_1, . . . , j_k are removed from the set of the integers 1 to n. In this case, the sanitized signature data is σ′=(M′,D′,R′,w_{j_1}, . . . , w_{j_k},IND).

In the sanitized signature data σ′, the original messages of the blocks specified by SIND are deleted and the information on the messages is w_{j_1}, . . . , w_{j_k}. The values w_{j_1}, . . . , w_{j_k} are hash values. Because a hash function generally satisfies the property that the information on the original data is not leaked from the hash values, it is guaranteed that the information on the original messages M_{j_1}, . . . , M_{j_k} is not leaked from w_{j_1}, . . . , w_{j_k}.

### [Signature Verification]

Next, the following describes signature verification. The verifier V receives the verification key vk and sanitized signature data σ′ as the input.

Next, the verifier V calculates w_i=H(M_i∥r_i) for the indexes i included in IND of the sanitized signature data σ′. Because IND is a set composed of the integers, 1 to n, from which j_1, . . . , j_k are removed, combining those integers with w_{j_1}, . . . , w_{j_k} included in σ′ results a full set of w_1, . . . , w_{n}.

Furthermore, the verifier V confirms that e(D′,g_2)=e(w,Y) is satisfied where w=w_1× . . . ×w_{n+1}. If the equation is not satisfied, the signature is invalid, the message indicating “reject” is output, and the processing is stopped.

If e(D′,g_2)=e(w,Y) is satisfied, the message indicating “accept” is output assuming that the signature is valid.

Next, the following describes the operation of the Second exemplary embodiment of the present invention that operates in the same configuration as that of the First exemplary embodiment described above. In this exemplary embodiment, a change to an original document is made by changing the original messages to the hash values of the original messages. In this exemplary embodiment, when a signed document is generated, the signer A generates restoration validity proving auxiliary data ARI. The restoration validity proving auxiliary data is data used for generating the restoration data and the restoration validity proving data RI when the changer S (who corresponds to the sanitizer S in the signature scheme described in Non-Patent Document 3 given above) makes a change.

In this exemplary embodiment, it is assumed that (k,q,(G_1,G_2,G_T,e),g_2,Y,H), which is generated in the same way as in the signature scheme described in Non-Patent Document 3 described above, is disclosed as the verification key vk_s of the original signer A. It is also assumed that the original signer A has (x) as the signature key sk_s corresponding to the verification key vk_s.

Referring again to FIG. 7 and FIG. 8, the following describes the signed original document creation processing. The original signer A enters the signature key sk_s to a signature device 10 (step 101).

Next, the original signer A creates an original document M, to which the signature is to be added, using an original document creation unit 10-1 (step 102).

Next, the original signer A enters the signature key sk_s and the original document M into a signature generation unit 10-2 to generate a signed original document OSIG (step 103). In response to this input, the signature generation unit 10-2 generates a signed original document OSIG=(σ,SI,ARI) that includes restoration validity proving auxiliary data ARI={SI,r_1, . . . , r_n}.

The signature generation unit 10-2 sends the created signed original document OSIG to a document saving device 20 (step 104). The document saving device 20 that has received the signed original document OSIG stores the signed original document OSIG (step 105).

Next, referring again to FIG. 9 and FIG. 10, the following describes the signed original document change processing. First, the changer S selects a signed original document OSIG, which will be disclosed, using a document selection unit 40-1 of a change position specification device 40 (step 201).

Next, the changer S uses a change position search unit 40-2 to search the blocks of the signed original document OSIG for blocks including non-disclosure information and generates a set SIND={i_1, . . . , i_k} that composed of the indexes of the blocks each including non-disclosed information (step 202).

Next, the change position specification device 40 sends the signed original document OSIG and the change-block index set SIND to a change device 50 (step 203).

The changer S enters the verification key vk_s and the signed original document OSIG into a signature verification unit 50-1 for verifying the signature (step 204). If the original signature data σ is invalid, the signature verification unit 50-1 outputs a message to indicate rejection. If the original signature data σ is valid, the signature verification unit 50-1 sends the signed original document OSIG and the index set SIND to a change processing unit 50-2.

Upon receiving the signed original document OSIG, which includes the restoration validity proving auxiliary data ARI, and the change-block index set SIND, the change processing unit 50-2 performs sanitization (adds a change to the hash values of the original message) according to the change-block index set SIND, and generates a signed changed-document SSIG=(σ′).

In addition, the change processing unit 50-2 generates restoration validity proving data RI={M_{i_1}, . . . , M_{i_k},SI′,r_{i_1}, . . . , r_{i_k}} that includes the original message before being sanitized and SI′={A_{i_1}, . . . , A_{i_k}}.

The change processing unit 50-2 sends the signed changed-document SSIG, which was generated as described above, to a disclosed document saving device 60, and the restoration validity proving data RI to a restoration validity proving data saving device 80 (step 205).

The disclosed document saving device 60 stores the received signed changed-document SSIG and discloses it. The restoration validity proving data saving device 80 stores the received restoration validity proving data RI (step 206).

Next, referring again to FIG. 11 and FIG. 12, the following describes the signed changed-document verification processing. First, the verifier V selects a signed changed-document SSIG, which is saved in the disclosed document saving device 60, using a document selection unit 30-1 of a verification device 30 (step 301).

Next, the verifier V confirms whether or not there are blocks, which are included in the blocks of the signed changed-document SSIG and are required to be restored, using a restoration position search unit 30-2 (step 302). If there are restoration-required blocks, the restoration position search unit 30-2 generates a block index set RIND={a_1, . . . , a_1} (where l is an integer equal to or smaller than k).

If there are restoration-required blocks, the restoration position search unit 30-2 sends the signed changed-document SSIG and the restoration-required position index set RIND to the restoration device 70.

Upon receiving the signed changed-document SSIG and the restoration-required block index set RIND, a signature verification unit 70-1 of the restoration device 70 verifies the signed changed-document SSIG using the verification key vk_s (step 304). If the signature on the signed changed-document SSIG is invalid, the signature verification unit 70-1 outputs a message indicating that the signature is invalid and stops the processing.

On the other hand, if the signature on the signed changed-document SSIG is valid, a restorability judgment unit 70-2 judges whether or not the blocks specified by the restoration-required block index set RIND may be restored (step 305). If there is a block that must not be restored, the restorability judgment unit 70-2 outputs a message indicating that the block may not be restored and stops the subsequent processing.

If it is judged that all blocks specified by the restoration-required block index set RIND may be restored, a restoration processing unit 70-3 restores the contents of the blocks having the indexes, which are specified by the restoration-required position index set RIND, based on the restoration validity proving data RI, using the signed changed-document SSIG, the restoration-required position index set RIND, and the restoration validity proving data RI, generates a signed restored-document RSIG, and sends the generated signed restored-document RSIG to the verification device 30 (step 306).

More specifically, based on the restoration-required position index set RIND, the restoration processing unit 70-3 first adds M_{a_1}, . . . , M_{a_1} to M′, included in the signed changed-document SSIG, to produce M″.

Next, the restoration processing unit 70-3 calculates D″=D′×A_{a_1}× . . . ×A_{a_1} using A_{a_1}, . . . , A_{a_1} included in the restoration validity proving data RI. In addition, the restoration processing unit 70-3 adds r_{a_1}, . . . , r_{a_1}, included in the restoration validity proving data RI, to R′ included in the signed changed-document SSIG (to produce R″). The restoration processing unit 70-3 generates the set W″ generated by removing {w_{a_1}, . . . , w_{a_1}} from {w_{j_1}, . . . , w_{j_k}} to produce the set W″. After the processing described above, the signed restored-document RSIG becomes (M″,D″,R″,W″).

A signature verification unit 30-3 of the verification device 30, which has received the signed restored-document RSIG, verifies the signed restored-document RSIG using the verification key vk_s (step 303). If the signature on the signed restored-document RSIG or on the signed changed-document SSIG is valid, the signature verification unit 30-3 accepts the signature and, if the signature is invalid, outputs a message to indicate rejection.

As described above, the present invention may be advantageously implemented by introducing the signature scheme described in Non-Patent Document 3.

### Third Exemplary Embodiment

Next, the following describes a Third exemplary embodiment of the present invention that implements a document disclosure system using the Chameleon hash function described in Non-Patent Documents 4 and 5 in the same configuration as that of the First exemplary embodiment described above. Although the present invention may be Implemented using the Chameleon hash function other than the one described in Non-Patent Documents 4 and 5, the description below assumes that the Chameleon hash function described in Non-Patent Document 4 and the electronic sanitization technology described in Non-Patent Document 3 are used.

The description of Patent Documents 4-5 is incorporated by reference into this specification.

First, the following briefly describes the Chameleon hash function described in Non-Patent Document 4. Let tr be a trapdoor. Then, that the function CH_{tr}( ) is a Chameleon hash function means that the following property is satisfied.
(1) An entity that does not know tr cannot find the value of x from y(=CH_{tr}(x)).
(2) An entity that does not know tr cannot find x and y that satisfy CH_{tr}(x)=CH_{tr}(y).
(3) An entity that knows tr can find Z, which satisfies CH_{tr}(z)=y, from y(=CH_{tr}(x)) and x.

The Chameleon hash function is composed of three components: key generation, hash calculation, and collision calculation.

First, the following describes key generation. A k-bit prime number p is randomly selected with k as the security parameter. In this case, it is desirable from the safety point of view that p satisfy p=2P′+1 where p′ is a prime number.

Let Z*_p be a set of integers each of which is 1 or larger and smaller than p and is relatively prime with p. Let Q_p be a set of x's each of which has y that satisfies x=ŷ2 mod p. Let q be the order of Q_p. Let g be the generator of Q_p.

Under this condition, x that is 1 or larger and is smaller than q is randomly selected to calculate y=ĝx. In addition, an ordinary hash function H that receives a bit string of an arbitrary length and outputs a q-bit bit string is selected. (g,y,H) obtained in this way is the public key, and x is a trapdoor. Assume that 1. the hash function H satisfies the property that x cannot be calculated from y=H(x) and that 2. x and y satisfying 2. H(x)=H(y) cannot be calculated.

Next, the following describes the hash calculation CH((g,y,H),m,r,s). Consider the calculation of the hash value of m using the public key (g,y,H) and random numbers r and s. To do so, e=H(m∥r) is calculated first, c=r−(ŷ{e}ĝ{s} mod p) mod q is calculated, and c is output as the hash value of m.

Next, the following describes the collision calculation COL((g,y,H),x,c,(m,r,s),m′). Consider that the public key (g,y,H), the trapdoor x, and c, m, r, s, and m′ satisfying c=r−(ŷ{H(m∥r)}ĝ{s} mod p) mod q are received as the input and that r′ and s′ satisfying c=r′−(ŷ{m′∥r′}g^{̂}{s′} mod p) mod q are calculated. To do so, the integer k′ that is 1 or larger and smaller than q is randomly selected and r′=c+(ĝ{k′} mod p) mod q, e′=H(m′∥r′), and s′=k′−e′x mod q are calculated. As a result, m′, r′, and s′ are output as the collision of m, r, and s.

Next, the following describes the operation of the Third exemplary embodiment of the present invention that operates in the same configuration as that of the First exemplary embodiment described above. In this exemplary embodiment, a predetermined changer S has the trapdoor of the Chameleon hash function described in Non-Patent Document 4 given above and discloses the public key. The signer A receives the public key of the Chameleon hash function of the changer S when the signer A adds a signature. In this exemplary embodiment, the changer S may change any given message as a change to the original document using the trapdoor.

In this exemplary embodiment, assume that (k,q,(G_1,G_2,G_T,e),g_2,Y,H), which is generated similarly using the Chameleon hash function, is disclosed as the verification key vk_s of the original signer A. Assume that the original signer A has (x) as the signature key sk_s corresponding to the verification key vk_s. In addition, assume that (g,y,H_2) is disclosed as the public key pk of the changer S. Also assume that the changer S has the trapdoor tr=(X_2) corresponding to the public key pk.

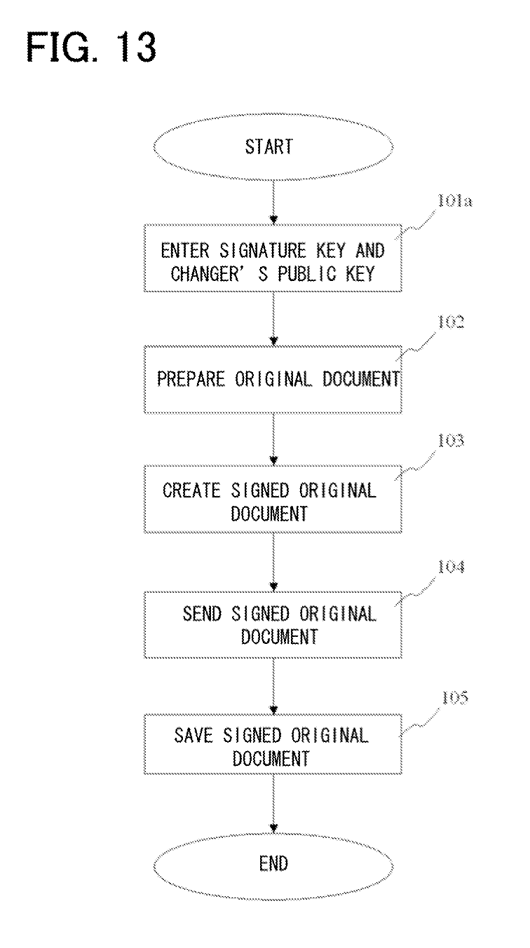

FIG. 13 is a flowchart showing the flow of the original signature generation processing using the Chameleon hash function. The following describes the signed original document creation processing in this exemplary embodiment with reference to FIG. 7 and FIG. 13. The original signer A enters the signature key sk_s and the public key pk of the changer S into a signature device 10 (step 101a).

Next, the original signer A creates an original document M, to which the signature is to be added, using an original document creation unit 10-1 (step 102).

Next, the original signer A enters the signature key sk_s, the public key pk of the changer S, and the original document M into a signature generation unit 10-2 to generate a signed original document OSIG (step 103).

More specifically, the signature generation unit 10-2 randomly selects k-bit r_{1}, . . . , r_{n+1},s_{1}, . . . , s_{n+1} and sets R=(r_{1}, . . . , r_{n+1},s_{1}, . . . , s_{n+1}). Next, the signature generation unit 10-2 calculates w_i=CH(pk,M_i,r_i,s_i) and calculates w_{n+1}=CH(pk,w_{—1∥w}_2∥ . . . ∥w_n,r_{n+1},s_{n+1}) (where, i is 1,2, . . . , n). In addition, the signature generation unit 10-2 calculates A_i=(w_i)̂x for i=1,2, . . . , n+1 and calculates D=A_1×A_2× . . . ×A{n+1}. After that, (M,D,R) given above is used as the original signature data σ.

In addition, the signature generation unit 10-2 calculates H(M_i)=h_i and generates the restoration validity proving auxiliary data ARI={h_1, . . . , h_n}. Finally, the signature generation unit 10-2 generates a signed original document OSIG=(σ,ARI) that includes the restoration validity proving auxiliary data ARI={h_1, . . . , h_n}.

The signature generation unit 10-2 sends the created signed original document OSIG to a document saving device 20 (step 104). The document saving device 20 that receives the signed original document OSIG stores the signed original document OSIG (step 105).

Next, referring again to FIG. 9 and FIG. 10, the following describes the signed original document change processing. First, the changer S selects a signed original document OSIG, which will be disclosed, using a document selection unit 40-1 of a change position specification device 40 (step 201).

Next, the changer S searches the blocks of the signed original document OSIG for the blocks, which include non-disclosed information, using a change position search unit 40-2 and generates a set SIND={i_1, . . . , i_k} composed of the indexes of the blocks including non-disclosed information (step 202).

Next, the change position specification device 40 sends the signed original document OSIG and the index set SIND to a change device 50 (step 203).

Next, the changer S enters the verification key vk_s and the signed original document OSIG into a signature verification unit 50-1 to verify the signature (step 204). If the original signature data σ is invalid, the signature verification unit 50-1 outputs a message indicating rejection. If the original signature data σ is valid, the signature verification unit 50-1 sends the signed original document OSIG and the change-block index set SIND to a change processing unit 50-2.

Upon receiving the signed original document OSIG including the restoration validity proving auxiliary data ARI, the change-block index set SIND, and the trapdoor x_2, the change processing unit 50-2 calculates w_i=CH(pk,M_i,r_i,s_i) (where, i is 1,2, . . . , n). In addition, the change processing unit 50-2 calculates COL(pk,x_2,w_{i_j},(M_{i_j},r_{i_j},s_{i_j}),M′_{i_j}) using the changed message M′_{i_1}, . . . , M′_{i_k} specified by the changer S to produce (M′_{i_j},r′_{i_j},s′_{i_j}).

Next, the change processing unit 50-2 sets M′_j=M_j for the index j not included in the change-block index set SIND, sets M′_j=M′_j for the index j included in the change-block index set SIND, and sets M′=(M′_1, . . . , M′_n). Similarly, the change processing unit 50-2 sets r′_j=r_j for the index j not included in the change-block index set SIND, sets r′_j=r′_j for the index j included in the change-block index set SIND, sets s′_j=s_j for the index j not included in the change-block index set SIND, sets s′_j=s′_j for the index j included in the change-block index set SIND, and sets R′=(r′_1, . . . , r′_n,s′_1, . . . , s′_n).

As described above, the signed changed-document SSIG=(σ′)=(M′,D,R′) is generated.

In addition, the change processing unit 50-2 generates the restoration validity proving data RI={M_{i_1}, . . . , M_{i_k},r_{i_1}, . . . , r_{i_k},s_{i_1}, . . . , s_{i_k},h_{i_1}, . . . , h_{i_k}}

The change processing unit 50-2 sends the signed changed-document SSIG, generated as described above, to a disclosed document saving device 60, and sends the restoration validity proving data RI to a restoration validity proving data saving device 80 (step 205).

The disclosed document saving device 60 stores the received signed changed-document SSIG and discloses it. The restoration validity proving data saving device 80 stores the received restoration validity proving data RI (step 206).

Next, referring again to FIG. 11 and FIG. 12, the following describes the signed changed-document verification processing. First, the verifier V selects a signed changed-document SSIG, saved in the disclosed document saving device 60, using a document selection unit 30-1 of the verification device 30 (step 301).

Next, the verifier V checks the blocks of the signed changed-document SSIG for restoration-required blocks using a restoration position search unit 30-2 (step 302). If there are restoration-required blocks, the restoration position search unit 30-2 generates the block index set RIND={a_1, . . . , a_1} (where 1 is an integer equal to or smaller than k).

If there are restoration-required blocks, the restoration position search unit 30-2 sends the signed changed-document SSIG and the restoration-required position index set RIND to a restoration device 70.

Upon receiving the signed changed-document SSIG and the restoration-required block index set RIND, a signature verification unit 70-1 of the restoration device verifies the signed changed-document SSIG using the verification key vk_s (step 304). If the signature on the signed changed-document SSIG is invalid, the signature verification unit 70-1 outputs a message indicating that the signature is invalid and stops the processing.

On the other hand, if the signature on the signed changed-document SSIG is valid, a restorability judgment unit 70-2 judges if the blocks specified by the restoration-required block index set RIND may be restored (step 305). If there is a block that must not be restored, the restorability judgment unit 70-2 outputs a message indicating that the block may not be restored and stops the subsequent processing.

If it is judged that all blocks specified by the restoration-required block index set RIND may be restored, a restoration processing unit 70-3 restores the contents of the blocks, which have the indexes specified by the restoration-required position index set RIND, based on the restoration validity proving data RI, using the signed changed-document SSIG, the restoration-required position index set RIND, and the restoration validity proving data RI, generates a signed restored-document RSIG, and sends the generated signed restored-document RSIG to a verification device 30 (step 306).

More specifically, the restoration processing unit 70-3 first sets M″_{j}=M_{j} (j is included in RIND) and M″_{j}=M′_{j} (j is not included in RIND). Similarly, the restoration processing unit 70-3 sets r″_{j}=r_{j} (j is included in RIND) and r″_{j}=r′_{j} (j is not included in RIND) and sets s″_{j}=s_{j} (j is included in RIND) and s″_{j}=s′_{j} (j is not included in RIND). The restoration processing unit 70-3 sets M″=(M″_{1}, . . . , M″_{n}) and R″=(r″_{1}, . . . , r″_{n},s″_{1}, . . . , s″_{n}).

In addition, the restoration processing unit 70-3 sets the restoration validity proving data RP=(M_{a_1}, . . . , M_{a_1},h_{a_1}, . . . , h_{a_1}). In this case, the signed restored-document RSIG becomes (M″,D,R″,RP).

A signature verification unit 30-3 of the verification device 30, which has received the signed restored-document RSIG, verifies the signed restored-document RSIG using the verification key vk_s and the public key pk (step 303).

More specifically, the signature verification unit 30-3 confirms that h_{a_i}=H(M_{a_i}) where i=1,2, . . . , 1. Next, the signature verification unit 30-3 calculates w_{i}=CH(pk,M″_{i},r″_{i},s″_{i}) where i=1,2, . . . , n. In addition, the signature verification unit 30-3 calculates w_{n+1}=CH(pk,w_1∥ . . . ∥w_n,r″_{n+1},s″_{n+1}). Furthermore, the signature verification unit 30-3 confirms that e(D′,g_2)=e(w,Y) is satisfied where w=w_1× . . . ×w_{n+1}.

If the signature on the signed restored-document RSIG or on the signed changed-document SSIG is valid, the signature verification unit 30-3 accepts the signature and, if the signature is invalid, outputs a message to indicate rejection.

As described above, the validity of the contents of a change made by the changer S may be confirmed in this exemplary embodiment by accepting a change added to any message using the trapdoor of the changer S and then restoring it.

While the preferred exemplary embodiments of the present invention have been described above, it is to be understood that the technical scope of the present invention is not limited to the description of the exemplary embodiments. For example, though an example in which the present invention is applied to an electronic document disclosure system has been described in the exemplary embodiments above, the present invention may be applied also to a system in which other content (electronic data), such as image data, moving image data, and music data, to which a predetermined transformation has been added, are disclosed.

Although the functions and the processing means of the devices shown in FIG. 2 to FIG. 6 may be configured by hardware, they may also be executed by recording programs, which execute the functions, on a computer-readable recording medium and by causing a computer to read the programs from recording medium for execution. The computer-readable recording medium refers to a recording medium, such as a flexible disk, a magnetic optical disk and a CD-ROM, and a storage medium such as a hard disk device included in a computer system. In addition, the computer-readable storage medium includes a medium (transmission medium or transmission wave) in which programs are dynamically stored for a limited time, for example, when programs are sent via the Internet, and a medium such as a volatile memory in a computer, which works as a server when programs are sent, where programs are held for a fixed period of time.

### INDUSTRIAL APPLICABILITY

The present invention is advantageously applicable to the disclosure of content, which includes non-disclosed information, over a communication network.

Although the above description is based on the exemplary embodiments, the present invention is not limited to the exemplary embodiments.

The exemplary embodiments and the examples may be changed and adjusted in the scope of the entire disclosure (including claims) of the present invention and based on the basic technological concept. In the scope of the claims of the present invention, various disclosed elements may be combined/replaced or selected in a variety of ways.

The further problems/objects and forms of the present invention will become apparent from the entire disclosure of the present invention including the claims.

### Mode 1

In the following, preferred modes are summarized. (refer to the content validity guaranteeing method of the first aspect).

### Mode 2

The content validity guaranteeing method as defined by mode 1, comprising the steps of:

allocating an index to each component of the signed content;

generating restoration validity proving data for a change position for each component of the singed content using the signed content, to which the signature of the original singer is added, and the index of the change position;

generating a signed restored-content having the signature of the original signer by receiving the verification key of the original signer, the signed changed-content having the signature of the original signer, the index of the restored position, and the restoration validity proving data; and

verifying that the content has been restored correctly by receiving the verification key of the original signer, the signed changed-content, and the signed restored-content.

### Mode 3

The content validity guaranteeing method as defined by mode 2, further comprising the steps of:

generating auxiliary data, which is used for generating the restoration validity proving data, for each component of the signed content when the signature is added to the original content; and

generating the restoration validity proving data using the auxiliary data, corresponding to the component, and the verification key of the original signer.

### Mode 4

The content validity guaranteeing method as defined by one of modes 1-3, further comprising the steps of:

generating a signed restored-content using the signed changed-content having the signature of the original signer, the verification key of the original signer, and the restoration validity proving data; and

verifying the signed restored-content having the signature of the original signer using the verification key of the original signer for guaranteeing content validity.

### Mode 5

The content validity guaranteeing method as defined by one of modes 1-4 wherein the change in the singed content having the signature of the original signer is made using an electronic signature scheme that allows the change position to be replaced by any message.

### Mode 6

(refer to the content disclosure system of the second aspect).

### Mode 7

The content disclosure system as defined by mode 6 wherein

said change device generates the restoration validity proving data, which will be used when said restoration device proves the validity of the restored contents, for each component of the signed content having the signature of the original signer and

said restoration device selects any given component of the signed changed-content having the signature of the original signer, restores the component to a state before the change, and verifies that the component is restored correctly using the verification key of the original signer.

### Mode 8

The content disclosure system as defined by mode 6 or 7 wherein

when a signature is added to the original content, auxiliary data, which will be used by said change device for generating the restoration validity proving data, is generated for each component of the original content and

said change device generates the restoration validity proving data using the auxiliary data corresponding to the component and the verification key of the original signer.

### Mode 9

The content disclosure system as defined by one of modes 6-8, further comprising:

a restoration device that receives the signed changed-content having the signature of the original signer, the verification key of the original signer, and the restoration validity proving data and generates a signed restored-content having the signature of the original signer; and

a verification device that receives the verification key of the original signer and the signed restored-content having the signature of the original signer and verifies the validity of the content by verifying the signature added to the signed restored-content having the signature of the original signer.

### Mode 10

The content disclosure system as defined by mode 6 or 7 wherein a change in the signed content having the signature of the original signer, which is added by said change device, is made using an electronic signature scheme that allows a change position to be replaced by any message.

### Mode 11

The content validity guaranteeing method as defined by one of modes 1-5 wherein

when the signed restored-content is created,

the signature key of the original signer added to the original document, the signature key of the original signer added to the change position, and the signed changed-content are used.

### Mode 12

The content validity guaranteeing method as defined by one of modes 1-5, and 11 wherein

the signature added by the original signer to the original content is composed of a product of the signatures added by the original signer to the components.

### Mode 13

The content validity guaranteeing method as defined by one of modes 1-5, 11, and 12 wherein

a change made by a changer to the signed original content having the signature of the original signer is composed of a result generated by dividing the signatures, added by the original signer to the original content, by the signature added by the original signer to the change portion.

### Mode 14

The content disclosure system as defined by one of modes 6-10 wherein

the signature added by the original signer to the original content is composed of a product of the signatures added by the original signer to the components.

### Mode 15

The content disclosure system as defined by one of modes 6-10, and 14 wherein

a change made by a changer to the signed original content having the signature of the original signer is composed of a result generated by dividing the signatures, added by the original signer to the original content, by the signature of the original signer added to the change portion.

What is claimed is:

1-25. (canceled)

26. A content validity guaranteeing method in which, when a changer changes a part of contents of a signed content using a verification key, corresponding to a signature key of an original signer, based on the signed content to which an electronic signature is added using the signature key of the original signer, a signed changed-content having the signature of the original signer is created for the changed-content and, when a verifier verifies that the content before the change is signed using the signature key of the original signer with information on the changed part before the change concealed, the verification key of the original singer is used, wherein
when the signed changed content is created, the signature of the original signer and contents of the content before the change for a change position are made to correspond to a part or a whole of the change position and the correspondence is saved in a restoration validity proving data storage device.

27. The content validity guaranteeing method as defined by claim 26, comprising the steps of:
allocating an index to each component of the signed content;
generating restoration validity proving data for a change position for each component of the singed content using the signed content, to which the signature of the original singer is added, and the index of the change position;
generating a signed restored-content having the signature of the original signer by receiving the verification key of the original signer, the signed changed-content having the signature of the original signer, the index of the restored position, and the restoration validity proving data; and
verifying that the content has been restored correctly by receiving the verification key of the original signer, the signed changed-content, and the signed restored-content.

28. The content validity guaranteeing method as defined by claim 27, further comprising the steps of:
generating auxiliary data, which is used for generating the restoration validity proving data, for each component of the signed content when the signature is added to the original content; and
generating the restoration validity proving data using the auxiliary data, corresponding to the component, and the verification key of the original signer.

29. The content validity guaranteeing method as defined by claim 26, further comprising the steps of:
generating a signed restored-content using the signed changed-content having the signature of the original signer, the verification key of the original signer, and the restoration validity proving data; and
verifying the signed restored-content having the signature of the original signer using the verification key of the original signer for guaranteeing content validity.

30. The content validity guaranteeing method as defined by claim 26 wherein the change in the singed content having the signature of the original signer is made using an electronic signature scheme that allows the change position to be replaced by any message.

31. A content disclosure system that includes a change device comprising:
a change processing unit that accepts a signed content having a signature of an original signer, a verification key of the original signer, and a request to change the signed content and creates a signed changed-content; and
a signature verification unit that generates restoration validity proving data for restoring the signed changed-content to a state before the change and proving validity of the restored contents, based on the request to change the signed content when the signed changed-content having the signature of the original signer is created, and provides the generated restoration validity proving data to a restoration device wherein
said restoration device restores the signed changed-content having the signature of the original signer to a state before the change using the verification key of the original signer, the signed changed content, and the restoration validity proving data and verifies that the signed changed-content is restored correctly using the verification key of the original signer.

32. The content disclosure system as defined by claim 31 wherein
said change device generates the restoration validity proving data, which will be used when said restoration device proves the validity of the restored contents, for each component of the signed content having the signature of the original signer and
said restoration device selects any given component of the signed changed-content having the signature of the original signer, restores the component to a state before the change, and verifies that the component is restored correctly using the verification key of the original signer.

33. The content disclosure system as defined by claim 31 wherein
when a signature is added to the original content, auxiliary data, which will be used by said change device for generating the restoration validity proving data, is generated for each component of the original content and
said change device generates the restoration validity proving data using the auxiliary data corresponding to the component and the verification key of the original signer.

34. The content disclosure system as defined by claim 31, further comprising:
a restoration device that receives the signed changed-content having the signature of the original signer, the verification key of the original signer, and the restoration validity proving data and generates a signed restored-content having the signature of the original signer; and
a verification device that receives the verification key of the original signer and the signed restored-content having the signature of the original signer and verifies the validity of the content by verifying the signature added to the signed restored-content having the signature of the original signer.

35. The content disclosure system as defined by claim 31 wherein a change in the signed content having the signature of the original signer, which is added by said change device, is made using an electronic signature scheme that allows a change position to be replaced by any message.

36. The content validity guaranteeing method as defined by claim 26 wherein
when the signed restored-content is created,
the signature key of the original signer added to the original document, the signature key of the original signer added to the change position, and the signed changed-content are used.

37. The content validity guaranteeing method as defined by claim 26 wherein
the signature added by the original signer to the original content is composed of a product of the signatures added by the original signer to the components.

38. The content validity guaranteeing method as defined by claim 26 wherein
a change made by a changer to the signed original content having the signature of the original signer is composed of a result generated by dividing the signatures, added by the original signer to the original content, by the signature added by the original signer to the change portion.

39. The content disclosure system as defined by claim 31 wherein
the signature added by the original signer to the original content is composed of a product of the signatures added by the original signer to the components.

40. The content disclosure system as defined by claim 31 wherein
a change made by a changer to the signed original content having the signature of the original signer is composed of a result generated by dividing the signatures, added by the original signer to the original content, by the signature of the original signer added to the change portion.
